(19) United States
(12) Patent Application Publication
(10) Pub. No.: US 2024/0041256 A1
(43) Pub. Date: Feb. 8, 2024

(54) GRILL HOUSING

(71) Applicant: Peter Luciani, JR., Buzzards Bay, MA (US)

(72) Inventor: Peter Luciani, JR., Buzzards Bay, MA (US)

(21) Appl. No.: 18/366,739

(22) Filed: Aug. 8, 2023

Related U.S. Application Data
(60) Provisional application No. 63/395,879, filed on Aug. 8, 2022.

(51) Int. Cl. A47J 37/07; E04H 1/12; A62C 3/00; A62C 37/10

(52) U.S. Cl. CPC A47J 37/0786; E04H 1/1205; A62C 3/006; A62C 37/10; A62C 2/06

(57) ABSTRACT

A protective grill housing assembly includes a bottom base panel, a rear panel, left and right side panels and a roof panel. Upper and lower spacer brackets are provided on the rear of the housing to prevent the grill housing from being placed too close to an adjacent structure. These spacers further ensure that the proper air gap is maintained to further insulate the adjacent structure from heat and flame transfer. A front panel assembly may includes at least one hinged door to provide access to the interior of the housing. Some embodiments may further include an integrated exploding fire extinguisher ball for quick automatic activation should a fire occur.

### CROSS-REFERENCE TO RELATED APPLICATIONS

This application claims the benefit of U.S. Provisional Patent Application No. 63/395,978 filed, Aug. 8, 2023, the entire contents of which is incorporated herein by reference.

### BACKGROUND

Embodiments of the invention relate to a grill housing assembly. More specifically, the present disclosure relates to a novel grill housing that has heat shields along at least the back, sides and top thereof to protect structures adjacent to an operational grill from heat and flare-ups and further includes a spacer on the rear side to provide an air gap and insure that the grill housing is not located too close to the adjacent structure.

Barbecue grills have seen widespread usage for outdoor cooking. Generally, barbecue grills have two types, i.e., gas grills and solid fuel grills. Gas barbecue grills use one or more groups of gas burners to cook food that is supported above the burners on fire grate. The fuel sources for a gas barbecue grill are typically LPG or natural gas. Solid fuel barbecue grills use a flammable solid fuel, typically charcoal. As a result, such grill is commonly referred to as a charcoal barbecue grill.

Generally, either type of barbecue grill has a cooking box comprising an openable or removable lid and burner hearth. A cooking box is formed between the open and the closed lid positions and the burner hearth. When cooking food, the lid can be positioned in the closed position. The lid is frequently opened to access the food and control the heat distribution within the cooking box. When storing the grill, it is best to position the lid in the closed position.

During operation of the barbecue grill, grease and other byproducts are discharged from the food. With prolonged and repeated use, grease and byproducts accumulate in the cooking box. With sufficient time and accumulation, the grease and byproducts can catch fire and result in unexpected, dangerous and intense flare-ups. These factors combined with the fact that most barbeque grills are positioned on a deck or patio adjacent to the wall of a house can produce potentially catastrophic results. Often the wall of the house is sided in vinyl or wood and the deck is formed from composite or wood decking. Since all of these materials are vulnerable to high heat, exposure to an operational grill that has been positioned too closely can result in melting and/or warping of the materials and in the worst case, the materials may start to burn.

There is therefore a need for a housing/shielding assembly for use in connection with a barbeque grill that provides protection between the operational grill and the structures adjacent thereto. There is a further need for an assembly for use in connection with a barbeque grill that acts as a barrier against transfer of heat and flame from the operational grill and the structures adjacent thereto. Still further, there is a need for a grill housing assembly that ensures that the grill is maintained at a safe distance from those structures. Finally, there is a need for a grill housing assembly that acts to contain possible grease fires while also preventing smoke and cooking residue from coating the adjacent structures.

### SUMMARY OF THE INVENTION

In accordance with the present disclosure a grill housing is provided that has heat shields along at least the sides back and top thereof to protect structures adjacent to an operational grill from heat and flare-ups.

In a first exemplary embodiment, the grill housing assembly generally includes a bottom base panel, a rear panel, left and right side panels and a roof panel. The panels used to form the grill housing may be formed from any suitable non-combustible material. Such materials may include, but are not limited to, steel, aluminum, non-flammable fiberboard and combinations thereof. Some exemplary embodiments are formed from ⅛″ thick aluminum panels.

Upper and lower spacer brackets are provided on the rear of the housing to prevent the grill housing from being placed too close to an adjacent structure. These spacers further ensure that the proper air gap is maintained thereby insulating the adjacent structure from heat and flame transfer.

The bottom edges of the panels or the corners of the bottom panel are reinforced and include a fitting therein that receive threaded leveling feet. The leveling feet allow the assembly to be adjusted to uneven surfaces so that the assembly can be plumb and level.

Some embodiments may include a front panel assembly which includes at least one hinged door to provide access to the interior of the housing. In some embodiments, the front panel assembly includes a top panel having an upper edge hinged to a front edge of the roof panel wherein the front panel hinges upwardly. The front panel assembly further may further include left and right hinged doors which are respectively hinged to the left and right side panels to swing outwardly.

Some embodiments may further include an integrated exploding fire extinguisher ball for quick automatic activation should a fire occur.

The entire housing assembly is configured and arranged such that a conventional-

sized gas, propane or charcoal grill may be received in and surrounded or enclosed by the housing.

In use, a grill is received within the housing such that the housing panels operate as a direct barrier against the transfer of heat and/or flame to the adjacent structures. The bottom panel can prevent flammable liquid grease and byproduct from accumulating on the deck or patio beneath the grill. The roof panel shelters the grill from inclement weather while also assisting in directing smoke and grease laden air from contaminating and soiling the adjacent structure.

In the event of a flare-up, the fire extinguisher ball, which is activated by flame (not heat), is automatically activated to disperse a dry or wet fire-fighting chemical agent to instantly extinguish the flames.

It is therefore an object of the present disclosure to provide an assembly for use in connection with a barbeque grill that provides protection between the operational grill and the structures adjacent thereto. It is a further object of the present disclosure to provide an assembly for use in connection with a barbeque grill that acts as a barrier against transfer of heat and flame from the operational grill to the structures adjacent thereto. Still further, it is an object of the present disclosure to provide an assembly for use in connection with a barbeque grill that acts as a barrier against transfer of heat and flame from the operational grill to the adjacent structures, while ensuring that the grill and the barrier assembly are maintained at a safe distance those structures. Finally, it is an object of the present disclosure to provide an assembly for use in connection with a barbeque grill that acts as a barrier against transfer of heat and flame from the operational grill to the adjacent structures while also preventing smoke and cooking residue from coating those structures.

### BRIEF DESCRIPTION OF THE DRAWINGS

While the specification concludes with claims particularly pointing out and distinctly claiming particular embodiments of the instant invention, various embodiments of the invention can be more readily understood and appreciated from the following descriptions of various embodiments of the invention when read in conjunction with the accompanying drawings in which:

FIG. 1 is a front perspective view of a first exemplary grill housing in accordance with the teachings of the present invention;

FIG. 2 is a rear perspective view thereof;

FIG. 3 is a side view thereof;

FIG. 4 is an exploded perspective view thereof;

FIG. 5 is a bottom view thereof;

FIG. 6 is a cross-sectional view thereof taken along line 6-6 of FIG. 5;

FIG. 7 is a front perspective view of another exemplary grill housing including an integrated front panel assembly to enclose the barbeque grill;

FIG. 8 is a rear perspective view thereof;

FIG. 9 is a front view thereof;

FIG. 10 is a side view thereof;

FIG. 11 is another front perspective view thereof with the upper panel portion and left and right door panel portions open to reveal the interior of the grill housing; and

FIG. 12 is a side view thereof.

### DETAILED DESCRIPTION OF THE EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

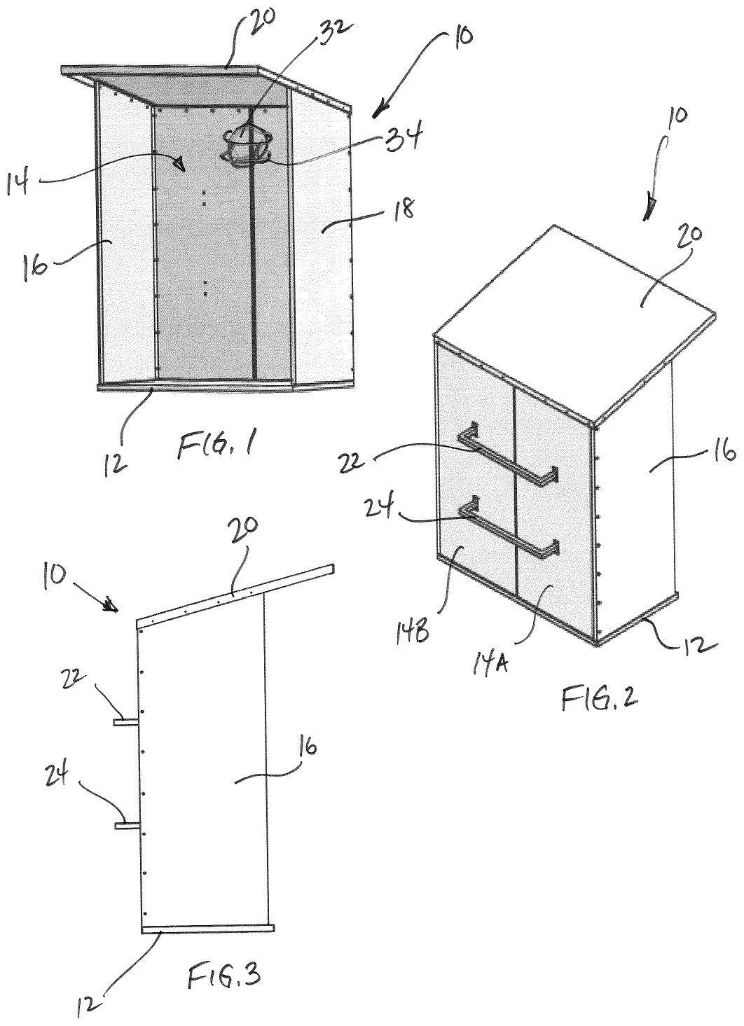

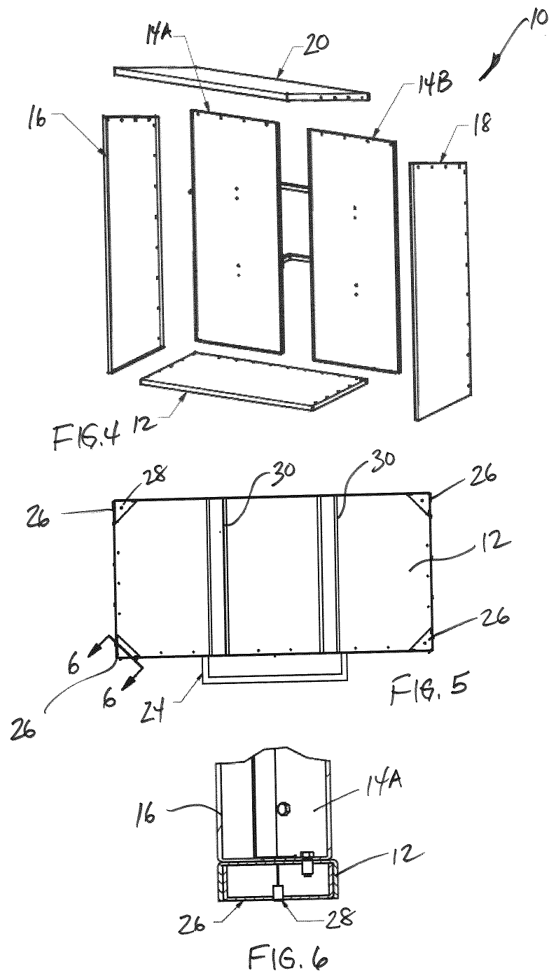

Referring now to the drawings, a first exemplary embodiment of a grill housing in accordance with the teachings of the present invention is illustrated and generally indicated at 10 in FIGS. 1-6.

The grill housing assembly 10 generally includes a bottom base panel 12, a rear

panel 14, left and right side panels 16, 18 and a roof panel 20. The rear panel 14 may be formed as two separate panels 14A,14B as illustrated, or a single panel. The panels 12, 14, 16, 18, 20 used to construct the grill housing 10 may be formed from any suitable non-combustible material such as steel, aluminum, non-flammable fiberboard, and combinations thereof. Other non-combustible materials are also contemplated. Some exemplary embodiments are formed from ⅛″ thick aluminum panels. An exemplary ranges of sizes for the grill housing 10 may be between 60-72 inches wide, 72-96 inches tall and 30-36 inches deep. An exemplary size as illustrated is about 68 inches wide, 82 inches tall and 34 inches deep.

The respective bottom, rear, side and roof panels 12, 14, 16, 18, 20 are cooperatively configured and arranged in assembled relation to receive, support and generally surround a barbeque grill of conventional size. The panels 12, 14, 16, 18, 20 may be secured with suitable removable or permanent fasteners or rivets, or may be permanently affixed to each other, such as by welding.

The roof panel 20 may be angled forwardly and upwardly from the rear panel 14 in order to direct smoke, heat and flames forwardly and away from the adjacent structure and to generally prevent grease stains on the adjacent structure.

The housing assembly 10 still further includes spacer brackets 22, 24 provided on the rear side of the rear wall 14 to prevent the grill housing 10 from being placed too close to an adjacent structure. These spacers 22, 24 further ensure that the proper air gap is maintained thereby insulating the adjacent structure from heat and flame transfer. The spacers 22, 24 may generally be C-shaped oriented in either a horizontal orientation (as shown) or a vertical orientation (not shown) and may be formed from a tubular material. The spacers 22, 23 may be removably secured or permanently affixed to the rear side of the back panel 14.

Referring to FIGS. 5-6, the bottom edges of the side panels 16, 18 and/or the corners of the bottom panel 12 are reinforced with corner brackets 26 and include a fitting therein that receive threaded leveling feet 28. The leveling feet 28 allow the assembly to be adjusted to uneven surfaces so that the assembly 10 can be plumb and level. The center portion of the base is provided with reinforcing beams 30 to support the weight of the grill in the center of the base 12.

Some embodiments may further include a explosive fire extinguisher ball 32 for quick automatic activation should a fire occur. Suitable fire extinguisher balls 32, such as the Elide™ Fire Extinguishing Ball, are known in the art. Preferred devices are activated by exposure to flame, rather than heat alone. A fire extinguishing device of the explosive type as contemplated herein is detailed in U.S. Pat. No. 6,796,382. The extinguisher ball may comprise a rigid plastic foam casing, with a thin plastic, exterior sheathing. Within the device, a low explosive yield detonator is located near the center, and is actuated by fuse(s) extending from the detonator, the end(s) of which extend to the exterior surface. The hollow casing may be charged with various fire-retardant chemical agents, including dry powders, liquid components or other configurations as disclosed therein.

The fire extinguishing ball 32 may be secured in a cage or rack 34, to the interior of the grill housing 10 on the upper portion of the back panel 14 or on the roof panel 20 so that it is located in a position above the grill that would be exposed to flame in the event of a grease fire or flare-up. Some fire extinguisher balls may also include an integrated ring (not shown) to hang the device from above.

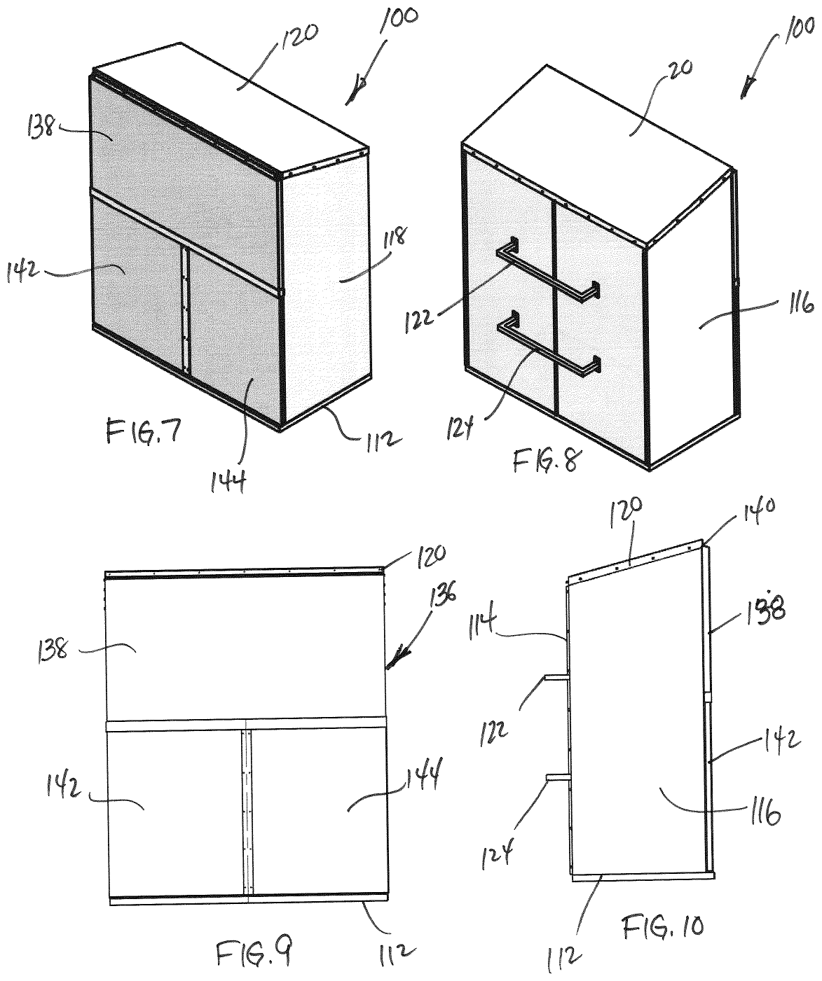

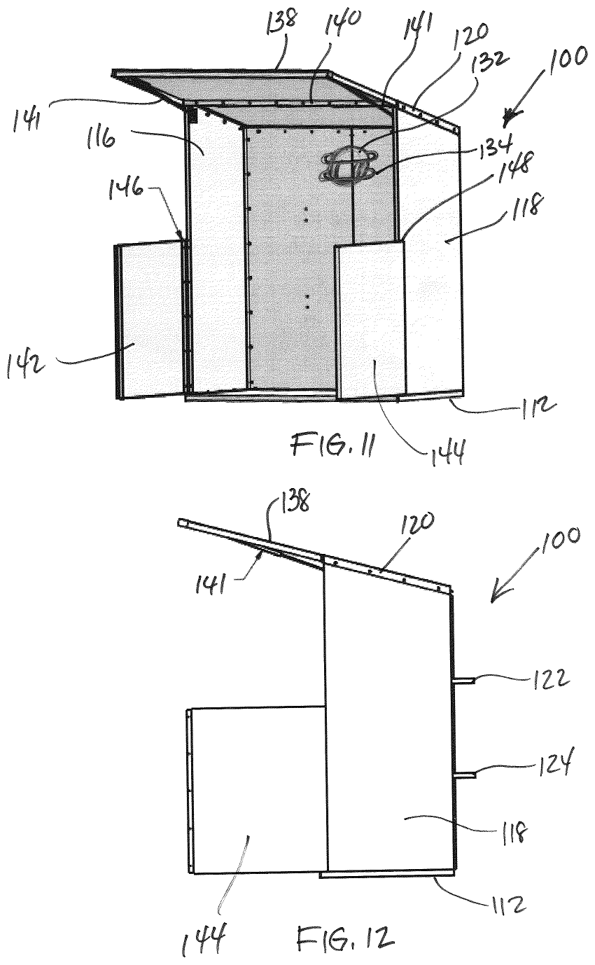

Turning to FIGS. 7-12, another exemplary embodiment of the grill housing is illustrated and generally indicated at 100. The grill housing 100 includes a bottom base panel 112, a rear panel 114, left and right side panels 116, 118 and a roof panel 120, and may further include a front panel assembly 136 which includes at least one hinged door to provide access to the interior of the housing 100. In the embodiment as illustrated, the front panel assembly 134 includes a top panel portion 138 having an upper edge hinged to a front edge of the roof panel 120 with a piano-type hinge 140, wherein the top panel portion 138 hinges upwardly. At least one gas-assisted spring piston 141 may be connected between the upper panel portion 138 of the front panel assembly 136 and the stationary roof panel 120 such that the upper panel portion 138 of the front panel assembly 136 is operatively assisted to move between a closed position when retracted and an open position when extended.

The front panel assembly 136 further may further include left and right hinged doors 142, 144 which are respectively hinged to the left and right side panels 116,118 with piano hinges 146, 148 so as to swing outwardly. The housing 100 also includes the spacing brackets 122,124 as described above. The grill housing 100 and respective panels are constructed of the same materials and sized to the same dimensions as previously described hereinabove, and also may include the noted fire extinguishing ball 132.

The entire housing assembly 100 is configured and arranged such that a conventional-sized gas, propane or charcoal grill may be received in and surrounded or entirely enclosed by the housing 100. In the event of a fire in the current embodiment 100, the front panel portions 138, 14, 144 may be closed to prevent the fire from spreading, which would also concentrate any flame towards the extinguisher ball 132 for activation and better direct the extinguishing materials onto the grill surface.

In general use, a grill is received within the present grill housing 10/100 such that the housing panels operate as a direct barrier against the transfer of heat and/or flame to any adjacent structures. The bottom panel 12/112 can further prevent flammable liquid grease and byproduct from accumulating on a deck or patio beneath the grill. Under normal storage and use conditions, the roof panel 20/120 shelters the grill from inclement weather while also assisting in directing smoke and grease laden air from contaminating and soiling the adjacent structure.

In the event of a flare-up, the fire extinguisher ball 32/132, which is activated by flame (not heat), is automatically activated to disperse a dry or wet fire-fighting chemical agent to instantly extinguish the flames.

It can therefore be seen that the exemplary embodiments 10/100 provide novel grill housing assemblies for use in connection with a barbeque grill to protects adjacent structures from dangerous grease fires and flare-ups.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A grill housing for enclosing a barbeque grill during storage and use thereof, comprising:
a base panel, a back panel, left and right side panels, and a roof panel each respectively formed from a non-combustible material and being cooperatively configured and arranged in assembled relation to receive, support and surround a barbeque grill; and
at least one spacing bracket extending rearwardly from said back panel to provide a gap between said grill housing and an adjacent structure.

2. The grill housing assembly of claim 1 wherein said base panel includes leveling feet in each corner thereof.

3. The grill housing of claim 1 wherein said at least one spacing bracket comprises spaced C-shaped mounting brackets extending horizontally across the back panel.

4. The grill housing of claim 2 wherein said at least one mounting bracket comprises spaced C-shaped mounting brackets extending horizontally across the back panel.

5. The grille housing of claim 1 wherein said roof panel is angled upwardly and a front edge thereof extends forward of the base panel.

6. The grille housing of claim 2 wherein said roof panel is angled upwardly and a front edge thereof extends forward of the base panel.

7. The grille housing of claim 3 wherein said roof panel is angled upwardly and a front edge thereof extends forward of the base panel.

8. The grille housing of claim 4 wherein said roof panel is angled upwardly and a front edge thereof extends forward of the base panel.

9. The grill housing of claim 1 further comprising a front panel assembly including at least one hinged door, and
wherein the base panel, back panel, left panel, right panel, roof panel and front panel assembly being cooperatively configured and arranged in assembled relation to receive, support and enclose a barbeque grill.

10. The grill housing of claim 9 wherein said front panel assembly includes an upper panel portion and lower left and right door portions,
said upper panel proportion hinged along a top edge thereof to a forward edge of said roof panel,
said lower left and right door portions hinged along respective left and right side edges thereof to said left and right side panels.

11. The grill housing of claim 10 further comprising at least one gas-assisted spring piston connected between the upper panel portion of the front panel assembly and the roof panel such that the upper panel portion of the front panel assembly is operatively assisted to move between a closed position when retracted and an open position when extended.

12. The grill housing assembly of claim 1 further comprising a fire extinguishing ball.

13. The grill housing assembly of claim 3 further comprising a fire extinguishing ball.

14. The grill housing assembly of claim 9 further comprising a fire extinguishing ball.

15. The grill housing assembly of claim 10 further comprising a fire extinguishing ball.

16. The grill housing of claim 12, wherein said fire extinguishing ball comprises a dry chemical flame activated exploding ball which is mounted in an upper portion of said housing.

17. The grill housing of claim 13, wherein said fire extinguishing ball comprises a dry chemical flame activated exploding ball which is mounted in an upper portion of said housing.

18. The grill housing of claim 14, wherein said fire extinguishing ball comprises a dry chemical flame activated exploding ball which is mounted in an upper portion of said housing.

19. The grill housing of claim 15, wherein said fire extinguishing ball comprises a dry chemical flame activated exploding ball which is mounted in an upper portion of said housing.
